(19) United States
(12) Patent Application Publication
(10) Pub. No.: US 2016/0109966 A1
(43) Pub. Date: Apr. 21, 2016

(54) TOUCH PEN AND ELECTRONIC DEVICE HAVING THE SAME

(71) Applicant: HON HAI PRECISION INDUSTRY CO., LTD., New Taipei (TW)

(72) Inventors: YI-CHENG LIN, New Taipei (TW); CHANG-DA HO, Tu-Cheng (TW); JEN-TSORNG CHANG, Tu-Cheng (TW)

(21) Appl. No.: 14/559,494

(22) Filed: Dec. 3, 2014

(30) Foreign Application Priority Data
Oct. 20, 2014 (TW) 103136104

(51) Int. Cl. G06F 3/0354; G06F 3/01; G06F 3/038

(52) U.S. Cl. CPC G06F 3/03545; G06F 3/038; G06F 3/016; G06F 2203/04105

(57) ABSTRACT

A touch pen includes a casing, a pen core received in the casing, a vibrating member, a pressure sensor received in the casing, and a processor. The pressure sensor is attached to the pen core, and can generate an electric signal after sensing a pressure delivered by the pen core. The processor is electrically coupled to the vibrating member, and configured to convert the electric signal to a control command. The control command is configured to control the vibrating member to vibrate.

### FIELD

The present disclosure relates to touch-sensitive technology, and more particularly, to a touch pen and an electronic device employing the touch pen.

### BACKGROUND

Many electronic devices, such as mobile phones, tablet computers, and multimedia players, employ touch-sensitive screens as input interfaces. When a user presses a virtual graphical button or icon displayed on a touch-sensitive screen, the graphical button or icon does not provide tactile feedback like a conventional keyboard, which has a travel distance for a keystroke when pressed.

Recently, touch pens are used as a substitute for fingers to perform touch operations on the touch-sensitive screens.

### BRIEF DESCRIPTION OF THE DRAWINGS

Implementations of the present technology will now be described, by way of example only, with reference to the attached figures.

FIG. 1 is a diagrammatic view of an embodiment of an electronic device including a touch pen.

FIG. 2 is a diagrammatic view of the touch pen in FIG. 1.

FIG. 3 is a cross-sectional view taken along line II-II of FIG. 2.

FIG. 4 is similar to FIG. 3, but showing the touch pen in another embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

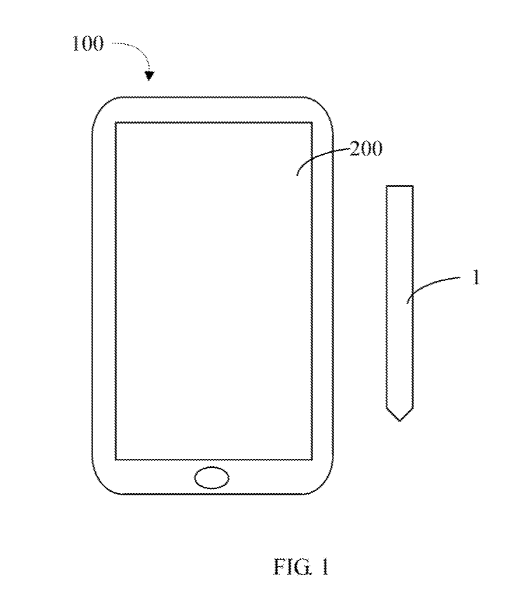

FIG. 1 illustrates an embodiment of an electronic device 100. The electronic device 100, such as a cell phone, a tablet computer, or a media player, includes a touch-sensitive screen 200. The electronic device 100 further includes a touch pen 1 for a user to perform touch operation on the touch-sensitive screen 200.

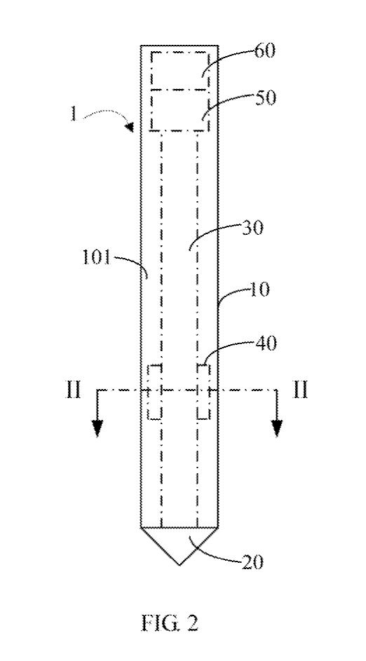

FIG. 2 illustrates that the touch pen 1 includes a casing 10, a touch head 20, and a pen core 30. The casing 10 is substantially hollow cylinder and longitudinally defines a receiving space 101. An end portion of the casing 10 defines an opening (not shown). The touch head 20 protrudes out of the casing 10 via the opening and is configured to perform touch operations on the touch-sensitive screen 200. The pen core 30 is received in the receiving space 101, and extends from the touch head 20 along a lengthwise direction of the casing 10. The touch head 20 can be made of silicon. In at least one embodiment, the touch head 20 is electrically coupled to the pen core 30, and is made of electro-conductive material such as metal.

In an alternative embodiment, the touch head 20 can be omitted, and an end of the pen core 30 directly protrudes out of the casing 10 via the opening to perform the touch operations on the touch-sensitive screen 200.

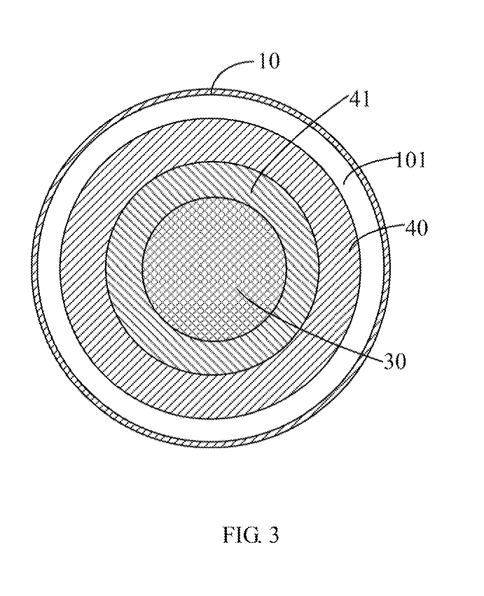

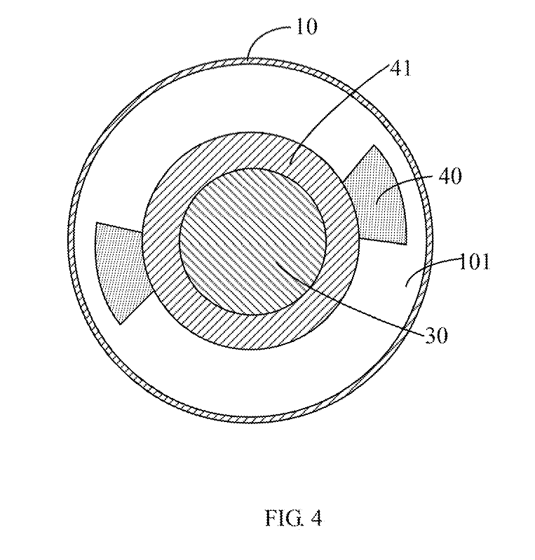

The touch pen 1 further includes at least one vibrating member 40 (shown in FIGS. 3-4), a pressure sensor 50, and a processor 60.

The vibrating member 40 can be secured to an exterior surface or interior surface of the casing 10. The vibrating member 40 can be made of a material selected from a group consisting of electroactive polymer (EAP), magnetostrictive material, electrostrictive material, and any combination thereof. FIG. 3 illustrates that in at least one embodiment, the touch pen 1 includes one vibrating member 40 coiled around a periphery of the pen core 30. FIG. 4 illustrates that in an alternative embodiment, the touch pen 1 includes two vibrating members 40 attached to the periphery of the pen core 30 and spaced from each other.

The pressure sensor 50 is received in and secured to the casing 10, and is attached to an end of the pen core 30 away from the touch head 20. When the touch head 20 is pressed (for example, the touch pen 1 clicks on the touch-sensitive screen 200 via the touch head 20), the touch head 20 pushes the pressure sensor 50 via the pen core 30. Then, the pressure sensor 50 generates an electric signal after sensing the pressure delivered by the touch head 30.

The processor 60 is electrically coupled to the vibrating member 40, and converts the electric signal to a control command. The control command is used to control the vibrating member 40 to vibrate, thereby providing a tactile feedback to the user. In at least one embodiment, the processor 60 is arranged to an end of the pressure sensor 50 away from the pen core 30.

FIGS. 3-4 illustrate that a securing base 41 is arranged between the vibrating member(s) 40 and the pen core 60. The securing base 41 is used to secure the vibrating member 40 to the pen core 60, and further deliver the vibration from the vibrating member 40 to the pen core 30. The securing base 41 can be made of metal, plastic, ceramic or glass. In at least one embodiment, the securing base 41 is made of metal.

In at least one embodiment, the pressure sensor 50 is made of piezoelectric ceramic, and is able to generate an electric voltage proportional to the sensed pressure. In this embodiment, the processor 60 generates the control command according to the electric voltage. The control command includes vibrating data proportional to the sensed pressure which controls the vibrating member 40 to vibrate according to the vibrating data. The vibrating data can be the amplitude or frequency of the vibration. In at least one embodiment, the vibrating data is amplitude of the vibration. That is, the greater the pressure sensed by the pressure sensor 50 is, the stronger the vibration provided to the user is.

In at least one embodiment, the pressure sensor 50 detects a first pressure along the lengthwise direction of the pen core 30 and a second pressure perpendicular to the lengthwise direction of the pen core 30, and generates a first electric voltage and a second electric voltage respectively proportional to the first pressure and the second pressure. In this case, the processor 60 generates a first control command and a second control command respectively according to the first pressure and the second pressure. The first control command includes first vibrating data proportional to the first pressure which controls the vibrating member 40 to vibrate along the lengthwise direction of the pen core 30, and the second control command includes second vibrating data proportional to the second pressure which controls the vibrating member 40 to vibrate perpendicular to the lengthwise direction of the pen core 30.

In at least one embodiment, the touch pen 1 further includes a storage unit (not shown) for storing an electric voltage threshold. The processor 60 further compares the sensed electric voltage with the electric voltage threshold before converting the electric signal to the control command. If the sensed electric voltage is greater than the electric voltage threshold, the processor 60 converts the electric signal to the control command which controls the vibrating member 40 to vibrate.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A touch pen comprising:
a casing defining a receiving space;
a pen core received in the receiving space;
at least one vibrating member;
a pressure sensor received in the casing, attached to an end of the pen core, and configured to sense a pressure delivered by the pen core and to generate an electric signal according to the sensed pressure; and
a processor electrically coupled to each of the at least one vibrating member, and configured to convert the electric signal to a control command, the control command configured to control each of the at least one vibrating member to vibrate.

2. The touch pen of claim 1, wherein the pressure sensor is configured to generate an electric voltage proportional to the sensed pressure; the processor is configured to generate the control command according to the electric voltage, the control command comprises vibrating data proportional to the sensed pressure which controls each of the at least one vibrating member to vibrate according to the vibrating data.

3. The touch pen of claim 2, wherein the vibrating data is amplitude or frequency of a vibration generated by each of the least one vibrating member.

4. The touch pen of claim 2, wherein the pressure sensor is made of piezoelectric ceramic.

5. The touch pen of claim 2, wherein the pressure sensor is further configured to detect a first pressure along a lengthwise direction of the pen core and a second pressure perpendicular to the lengthwise direction of the pen core, and generate a first electric voltage and a second electric voltage respectively proportional to the first pressure and the second pressure; the processor is further configured to generate a first control command and a second control command respectively according to the first pressure and the second pressure, the first control command comprises first vibrating data proportional to the first pressure which controls each of the at least one vibrating member to vibrate along the lengthwise direction of the pen core, and the second control command comprises second vibrating data proportional to the second pressure which controls each of the at least one vibrating member to vibrate perpendicular the lengthwise direction of the pen core.

6. The touch pen of claim 2, wherein the processor is further configured to compare the sensed electric voltage with an electric voltage threshold before converting the electric signal to the control command, and converts the electric signal to the control command if the sensed electric voltage is greater than the electric voltage threshold.

7. The touch pen of claim 1, further comprising a touch head, wherein an end portion of the casing defines an opening; the touch head protrudes out of the casing via the opening; the pen core extends from the touch head along a lengthwise direction of the casing.

8. The touch pen of claim 7, wherein the touch head is made of silicon.

9. The touch pen of claim 7, wherein the touch head is electrically coupled to the pen core, and is made of electro-conductive material.

10. The touch pen of claim 7, wherein the pressure sensor is attached to an end of the pen core away from the touch head.

11. The touch pen of claim 1, wherein each of the at least one vibrating member is secured to an exterior surface or interior surface of the casing.

12. The touch pen of claim 1, wherein each of the at least one vibrating member is made of a material selected from a group consisting of electroactive polymer, magnetostrictive material, electrostrictive material, and any combination thereof.

13. The touch pen of claim 1, wherein the at least one vibrating member is coiled around a periphery of the pen core.

14. The touch pen of claim 1, wherein a securing base is arranged between each of the at least one vibrating member and the pen core, and is configured to secure the vibrating member to the pen core and deliver a vibration generated by the vibrating member to the pen core.

15. An electronic device comprising:
a touch-sensitive screen; and
a touch pen for performing touch operations on the touch-sensitive screen, the touch pen comprising:
a casing defining a receiving space;
a pen core received in the receiving space;
at least one vibrating member;
a pressure sensor received in the casing, attached to an end of the pen core, and configured to sense a pressure delivered by the pen core and to generate an electric signal according to the sensed pressure; and
a processor electrically coupled to each of the at least one vibrating member, and configured to convert the electric signal to a control command, the control command configured to control each of the at least one vibrating member to vibrate.

16. The electronic device of claim 15, wherein the pressure sensor is configured to generate an electric voltage proportional to the sensed pressure; the processor is configured to generate the control command according to the electric voltage, the control command comprises vibrating data proportional to the sensed pressure which controls each of the at least one vibrating member to vibrate according to the vibrating data.

17. The electronic device of claim 16, wherein the vibrating data is amplitude or frequency of a vibration generated by each of the least one vibrating member.

18. The electronic device of claim 16, wherein the pressure sensor is made of piezoelectric ceramic.

19. The electronic device of claim 16, wherein the pressure sensor is further configured to detect a first pressure along a lengthwise direction of the pen core and a second pressure perpendicular to the lengthwise direction of the pen core, and generate a first electric voltage and a second electric voltage respectively proportional to the first pressure and the second pressure; the processor is further configured to generate a first control command and a second control command respectively according to the first pressure and the second pressure, the first control command comprises first vibrating data proportional to the first pressure which controls each of the at least one vibrating member to vibrate along the lengthwise direction of the pen core, and the second control command comprises second vibrating data proportional to the second pressure which controls each of the at least one vibrating member to vibrate perpendicular the lengthwise direction of the pen core.

20. The electronic device of claim 16, wherein the processor is further configured to compare the sensed electric voltage with an electric voltage threshold before converting the electric signal to the control command, and converts the electric signal to the control command if the sensed electric voltage is greater than the electric voltage threshold.
